(19) United States
(12) Patent Application Publication
(10) Pub. No.: US 2011/0050539 A1
(43) Pub. Date: Mar. 3, 2011

(54) MONOPOLE ANTENNA

(75) Inventor: LUNG-PAO CHEN, Tu-Cheng (TW)

(73) Assignee: HON HAI PRECISION INDUSTRY CO., LTD., Tu-Cheng (TW)

(21) Appl. No.: 12/629,124

(22) Filed: Dec. 2, 2009

(30) Foreign Application Priority Data
Aug. 26, 2009 (CN) 200920308841.3

(51) Int. Cl. H01Q 1/00

(52) U.S. Cl. 343/904

(57) ABSTRACT

A monopole antenna includes a substrate, a feed portion, a radiating portion, and a position ring. The substrate defines a via hole. The feed portion feeds electromagnetic signals by way of the via hole. The radiating portion is L-shaped, and includes a first radiator and a second radiator. One end of the first radiator is connected to the feed portion, and perpendicular to the substrate. One end of the second radiator is perpendicularly connected to the other end of the first radiator, and the other end of the second radiator is free. The position ring is configured between the feed portion and the substrate, to securely position the radiating portion on the substrate.

### BACKGROUND

1. Technical Field

Embodiments of the present disclosure relate to antennas, and especially to a monopole antenna.

2. Description of Related Art

Monopole antennas are gaining popularity, due to easy production and good performance. However, monopole antennas also have disadvantages, such as having frequency bands that may be offset by length or height of the position point, or dimensions of the monopole antennas.

A positioning method of the monopole antenna is by assistant devices, or other external structures. Thus, overcoming the above-described disadvantaged is desired.

### BRIEF DESCRIPTION OF THE DRAWINGS

FIG. 1 is a schematic diagram of a monopole antenna according to the present disclosure; and

FIG. 2 is a graph showing return loss of the monopole antenna of FIG. 1.

### DETAILED DESCRIPTION

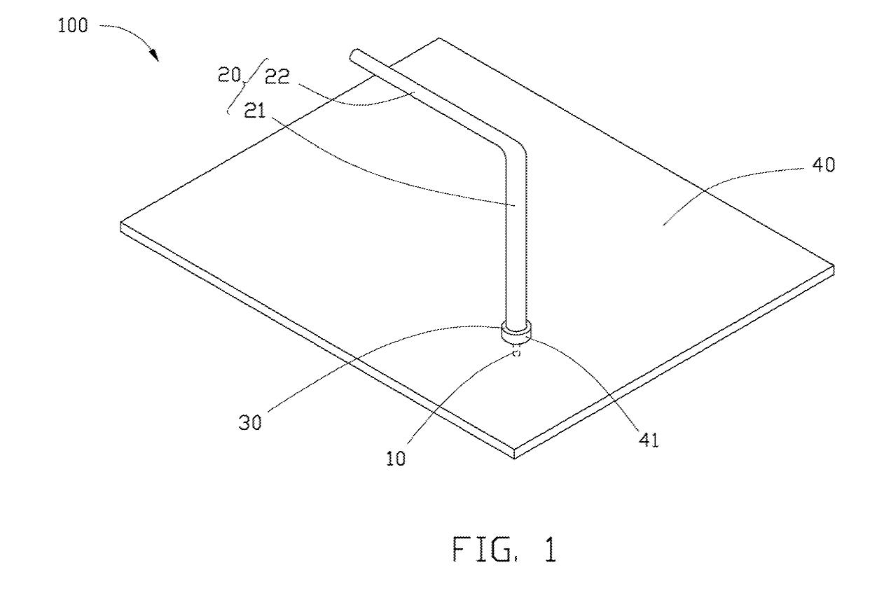

Referring to FIG. 1, a schematic diagram of a monopole antenna 100 as disclosed is shown. The monopole antenna 100 comprises a feed portion 10, a radiating portion 20, a position portion 30, and a substrate 40.

The substrate 40 defines a via hole 41.

The feed portion 10 feeds electromagnetic signals by way of the via hole 41.

The radiating portion 20 is L shaped, to transceive the electromagnetic signals. The radiating portion 20 comprises a first radiator 21 and a second radiator 22. One end of the first radiator 21 is connected to the feed portion 10. One end of the second radiator 22 is perpendicularly connected to other end of the first radiator 21, and the other end of the second radiator 22 is free. The first radiator 21 is perpendicular to the substrate 40.

In one embodiment, the first radiator 21 and the second radiator 22 are columnar. The first radiator 21 and the second radiator 22 are sectionally designed with different radii having gradually matched impedance, and broaden frequency bands of the monopole antenna 100.

The position ring 30 is configured between the feed portion 10 and the radiating portion 20, and positioned on the substrate 40. In one embodiment, a radius of the position ring 30 is larger than that of the via hole 41, and a radius of the feed portion 10 is approximately the same as the radius of the via hole 41. In one embodiment, the radiating portion 20 is securely positioned on the substrate 40 by the position ring 30, requiring no external device, making assembly more convenient.

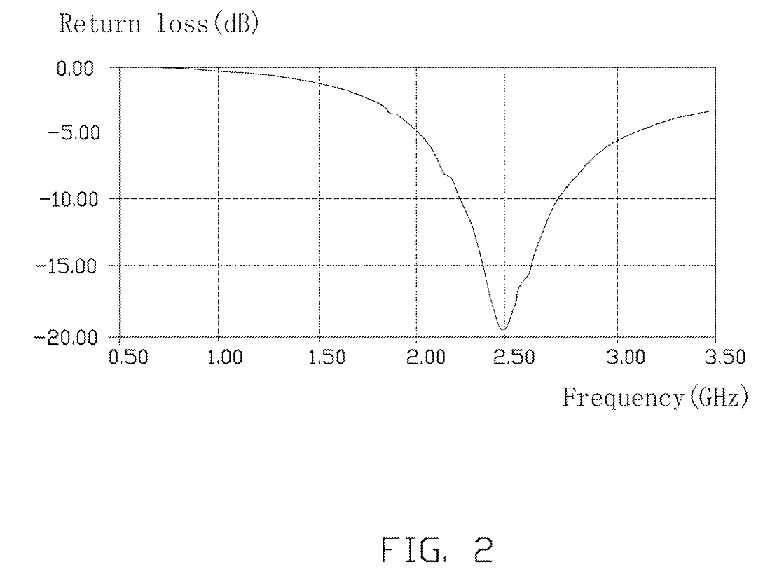

Referring to FIG. 2, return loss of the monopole antenna 100 is shown. When the radiating portion 20 operates at approximately 2.5 GHz, the return loss is less than −10 dB, which complies with WIFI standards.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A monopole antenna, comprising:
a substrate, defining a via hole;
a feed portion, to feed electromagnetic signals by way of the via hole;
a radiating portion being L-shaped, the radiating portion comprising:
a first radiator with one end connected to the feed portion, and perpendicular to the substrate; and
a second radiator comprising one end connected perpendicular to the other end of the first radiator, and the other end being free; and
a position ring, configured between the feed portion and the substrate, to securely position the radiating portion on the substrate.

2. The monopole antenna as claimed in claim 1, wherein a radius of the position ring is larger than a radius of the via hole.

3. The monopole antenna as claimed in claim 2, wherein the first radiator and the second radiator are columnar.

4. The monopole antenna as claimed in claim 3, wherein a radius of the first radiator and a radius of the second radiator are different.
